(19) United States
(12) Patent Application Publication
(10) Pub. No.: US 2007/0089125 A1
(43) Pub. Date: Apr. 19, 2007

(54) Content-processing system, method, and computer program product for monitoring the viewer's mood

(75) Inventor: Arjan Claassen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,610

(22) PCT Filed: Dec. 1, 2004
(86) PCT No.: PCT/IB04/52621

§ 371 Date: Jun. 19, 2006

(30) Foreign Application Priority Data
Dec. 22, 2003 (EP) 03104879.6

(51) Int. Cl. H04N 7/16; H04H 9/00; H04N 5/445; G08B 23/00

(52) U.S. Cl. 725/9; 725/37; 340/573.1; 725/46

(57) ABSTRACT

A content-processing system (100) processes a content (102) for presentation (103) to a user (104). The content-processing system (100) has input means (105) for receiving (106) commands (107) from the user (104) to control (108) the processing operation (101). The content-processing system (100) is arranged to modify (111) the processing operation (101) in dependence on the commands (107) received (106). The content-processing system (100) has a mood detector (109) for detecting a mood (110) of the user (104) to enable tailoring e.g. the content (102) or its presentation (103) to the mood (110) detected. The mood detector (109) is coupled (112) to the inputs means (105) and detects the mood (110) based on the received (106) commands (107).

The invention relates to a content-processing system for processing a content to be presented to a user.

The invention also relates to a mood detector for use in said system.

The invention also relates to a method and a computer program product for detecting a user's mood.

A content-processing system as described in the opening paragraph is known from WO 02/43391 A1. This document discloses a content-processing system in the form of a television processing content such as a television program for presentation to a user. The television comprises input means, e.g. a remote control, for receiving commands from the user to control the processing operation. Examples of commands include modifying a volume level, and selecting other content such as a previous or a subsequent preset channel. The television obeys the commands received by modifying the processing of the content accordingly. The television also comprises a mood detector for detecting a current mood of the user. Detecting the mood is based on capturing an image of a user's face by means of a camera. The mood detector analyzes the captured image so as to detect facial expressions that are present in the image. The detected mood is used to generate television program recommendations that are tailored to the user's mood.

It is a drawback of the known content-processing system that capturing an image by means of a camera and analyzing facial expressions involve a relatively high complexity and a relatively high cost of the content-processing system.

It is an object of the invention to provide a relatively simple and low-cost content-processing system of the type described in the opening paragraph.

The object is realized in that the content-processing system comprises input means for receiving commands from the user to control the processing operation, and a mood detector for detecting a user's mood, the mood detector being coupled to the input means, the content-processing system being arranged to modify the processing operation in dependence on the commands received, and the mood detector being arranged to detect the mood based on the received commands.

The invention is based on the recognition that a mood may be detected from the commands received by the input means. In particular, a state of boredom may be detected if the commands result in a relatively high frequency of changing the processing of the content.

Instead of having separate means for capturing an image, the input means that are used to control the processing operation are additionally used for detecting the mood. Therefore, the mood may be detected without separate means for capturing an image, without analyzing the image and without detecting facial expressions, such that the content processing system according to the invention may be relatively simple and relatively inexpensive.

U.S. Pat. No. 5,808,703 describes an apparatus that gives feedback to a user of a remote control device, such as that for a television, to indicate when the remote control is used excessively (channel surfing). The device detects transmission from a remote control device and counts the transmissions during a predetermined period of time. When a predetermined maximum number of commands from the remote control device is received, an indication thereof is provided to the viewer. This indication may take the form of a visual indication such as flashing a message, an auditory alarm, disabling of the remote control device by jamming the inferred signal, or automatically controlling the operation of the remote control device, which may include turning off the device.

The content-processing system processes a content for presentation to a user. The content-processing system may comprise or be part of, for instance, a receiver, a television set, a media player, a communication device, a smartphone, a general purpose computer, a personal computer, a stationary, a mobile or a wearable entertainment device, a gaming device, or a home cinema system. The content may comprise, for example, an audio component, a video component, a textual component, a tactile component, or a multimedia component. Examples of components and of the content are a broadcast event, a television program, a radio program, a track from a CD, a track from a DVD, an SMS message, an MMS message, a multimedia message, a mail message, a MIME message, a web page, a web service, a still image, a photo, a movie, an audio clip, a video clip, a commercial, or a game. The content may be stored locally in a memory or on a medium, or the content may be received from a medium. The medium may comprise, for example, air, a cable, an optical fiber, an Internet stream, a multicast, a webcast, an optical disc, a solid-state memory, or a memory stick. The content may have an analog or a digital format, for instance, an MP3 format, a MIME format, an SMS format, an MMS format, an EMS format, a DVB format, a DAB format, an HTML format, or a Java format. The content may be distributed with waves, in frames, in packets, or in a stream of packets. The content may be distributed with a broadcast, a multicast, or a unicast. The medium on which the content may be stored may be physically distributed to obtain distribution of the content.

The content-processing system comprises input means for receiving commands from the user to control the processing operation. The input means may be a computer input device, for example, a key, a button, a mouse, a touch pad, a touch screen, a laser beetle, a microphone, or another sensing device.

The commands may control the processing operation in various ways. In a first way, a command may have the purpose of selecting other content from the same medium, for instance, a subsequent or previous part of the content like a track, a scene, a viewpoint, a shot, or a passage. In a second way, a command may have the purpose of selecting other content from another medium, for instance, a subsequent or previous channel, stream, optical disc, or memory bank. In a third way, a command may have the purpose of blending two or more components into a single presentation, for instance, an overlay image, a mix of audio channels or a voice-over. In a fourth way, a command may have the purpose of selecting the display on which the content is presented, such as a display screen in the living room, a display screen on a tablet PC, a display screen on a handheld or wearable device, or an audio display worn by the user. In a fifth way, a command may have the purpose of modifying how the content is rendered on a display, for instance, increasing or decreasing a volume level, a speed, a tempo, a brightness level, a size, a color, a font, an acoustic effect, e.g. a reverberation, a spatial effect, a surround sound effect, or a visual effect such as, for example, panning, zooming, morphing, rasterizing, colorizing, posterizing.

The content-processing system is arranged to modify the processing operation in dependence on the commands received. This ensures that the commands received may be used to operate the content-processing system.

The content-processing system comprises a mood detector for detecting a user's mood. The mood detected may be, for example, a state of happiness, excitement, amusement, boredom, tiredness, laziness, eagerness, liveliness, relaxedness, sadness, restlessness, helplessness, being in doubt, or being determined. The detected mood may be used to improve the user interface of the content-processing system, for instance, by providing help when helplessness is detected, or by selecting compelling content when boredom is detected, or by generating content recommendations that are tailored to the user's mood.

The mood detector is coupled to the input means. The mood detector may be coupled to the input means with a physical connection such as a cable or a pair of conductors, but it may also be coupled in software, for instance, by an exchange of an event or a software signal that represents a received command.

The mood detector and the input means may be physically separate, while being operatively coupled. The input means may be present in, for example, a client device such as a PDA that is coupled to the mood detector present in e.g. a server computer, while being coupled by the Internet. The mood detector may also be distributed in itself, e.g. a plurality of computers may contribute to detecting the mood.

The mood detector is arranged to detect the mood based on the received commands. To achieve this, the mood detector may process one or more aspects of the received commands. A first aspect is e.g. a semantic of a received command. If, for instance, a received command has the purpose of increasing an audio volume level, the user is likely to be relatively interested in the content. Another example is that if a received command has the purpose of selecting another content, the user is likely to be relatively bored by the current content. Yet another example is that if a received command has the purpose of starting an action game, the user is likely to be relatively energetic. A second aspect is e.g. a context in which the command was received, or a state of the system at the time the command was received. An example is that if a television receives many pressed digits from the remote control in a relatively short period of time, the user is likely to be relatively bored, unless e.g. the television is displaying teletext pages. The state of the system may comprise settings for the processing of the content. If, for instance, a received command has the purpose of decreasing an audio volume level, the user is likely to be relatively uninterested, provided that the current audio volume level is not extremely loud. A third aspect may pertain to the time at which a command was received. This may be an absolute time, but it may alternatively be a relative time. Examples are a time of the day, a time with respect to a time from a program schedule like a program start time, or a time elapsed between the time a command was received and the time a previous command was received. A fourth aspect may be the content presented while a command is received. If, for example, a command was received to change the content while a fast-paced action movie was presented, the mood of the user is likely to be relatively relaxed. A fifth aspect is e.g. a history of the received commands and a pattern in the history, or a statistic; derived from the history. The user may expose a habit in commanding the system, and the habit may be taken into account for detecting the mood. If, for example, the user exposes the habit of daily selecting a content at substantially the same time of the day, a command for selection may be given less relevance for detecting e.g. a state of boredom of the user. These and still other aspects may be advantageously combined to improve the accuracy of the mood detector.

In an embodiment, the mood detector comprises pattern analysis means for detecting a presence of a pattern in the received commands, and the mood detector is arranged to detect the mood based on detecting the presence of the pattern. This may further enhance the accuracy of the mood detector because the pattern may provide a relatively reliable indication for the mood. An example of the pattern is an emphasis on navigating the content, rather than consuming the content. This navigation is typically performed by exploring indexes or overviews of available content. The indexes and overviews are examples of so-called meta-content that describe content. If relatively much time is spent on presenting meta-content rather than on presenting content, this may indicate that the user is not satisfied because he is not able to find content that is interesting to him. Examples of meta-content are a television program schedule, e.g. as from an EPG, a teletext page mainly listing page numbers of other teletext pages, a web jump station providing web pages with merely links or URLs, an index of a library of movies, or songs, and a web portal of a web search engine.

In another embodiment, the mood is a state of boredom, and the pattern is a relatively high frequency of received commands. A particularly relevant mood of the user is a state of boredom, because the content-processing system may e.g. be specially used for entertaining the user. If, for instance, the user is bored by the content, it is likely that the user selects another content. If the user is still bored by the other content, it is likely that the user selects yet another content. This causes a relatively high frequency of receiving commands for selecting the content. Such a pattern may be detected by monitoring the frequency of the received commands.

In yet another embodiment, the content-processing system is arranged to present alternative content in response to detection of the state of boredom by the mood detector. This has the advantage of an improved user interface of the system, because the content-processing system may tailor the alternative content to the mood detected. The content-processing system may present alternative content in various ways. In a first way, alternative content is presented as an overlay to the content. The overlay may provide a suggestion for another content. The overlay may comprise a symbol or icon indicating that other content is available. An example of other content is content that was stored by a storage device, e.g. a videorecorder (a VCR or a PVR), or a disk drive of a personal computer. Another example of other content is content that was stored but not presented to the user. The overlay may e.g. comprise a voice-over produced by a speech synthesizer, or mixing images or video signals. In a second way, the content-processing system may present alternative content on an output device that may or may not be part of the content-processing system.

The content-processing system may select alternative content based on the detected mood.

In a further embodiment, the mood detector comprises measuring means for determining a measure of the received commands and the mood detector is arranged to detect the mood if the measure exceeds a threshold. This may be a relatively simple way to detect a pattern. The measure may e.g. be the number of commands received in the last minute, or a weighted average of the commands received during the last 10 seconds, or a convolution over time of a function of the commands received. The threshold may be an integer, a floating point and may be negative or positive.

In a still further embodiment, the measuring means comprise storage means for storing a value, and the measuring means are arranged to update the value in response to a command being received. This may further simplify the mood detector, because the past, or all commands received so far, may be represented in the value. This alleviates the need for maintaining separate representations for each command received. The value may be stored in an analog or in a digital format. Examples are a voltage or current, an integer, a floating point, an array, or a table. The storage means may e.g. comprise a capacitor, an inductor, a latch, a register, a flipflop, or a random access memory. The update of the value may e.g. be based on an increment, a decrement, a multiplication, a weighted sum, an average, or a convolution over time. In some embodiments, the threshold is exceeded only when receiving a command. For these embodiments, it suffices to only update the value in response to a command being received. This has the advantage that a minimum number of updates is performed, thus saving on resources like energy, bandwidth, and, for software, computational complexity.

In another embodiment, the measuring means comprise a timer for determining a time and means for incrementing and decrementing the value, wherein the measuring means are arranged to increment the value with an increment in dependence on the command being received, and the measuring means are arranged to decrement the value with a decrement in dependence on the time. This is a relatively simple provision for detecting a frequency of received commands exceeding a threshold. The increment may be an integer, a floating point and may be negative or positive. The same holds for the decrement.

The increment may be unequal to zero if the command being received changes the content.

The above object and features of the content-processing system, the method and the computer program product of the present invention will be more apparent from the following description with reference to the drawings.

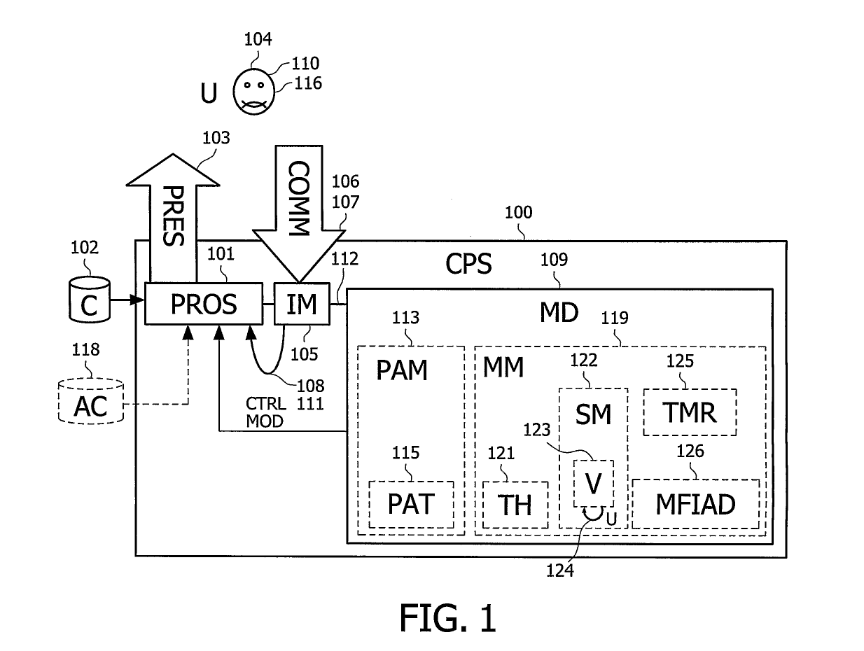

FIG. 1 shows a block diagram of a content-processing system according to the invention.

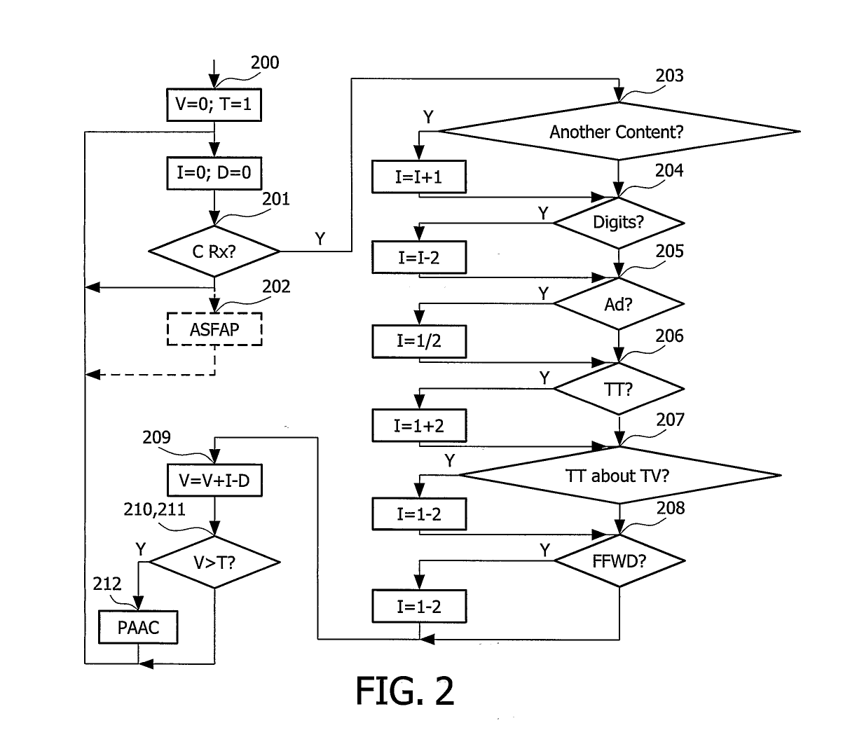

FIG. 2 shows a flowchart illustrating mood detection according to the invention.

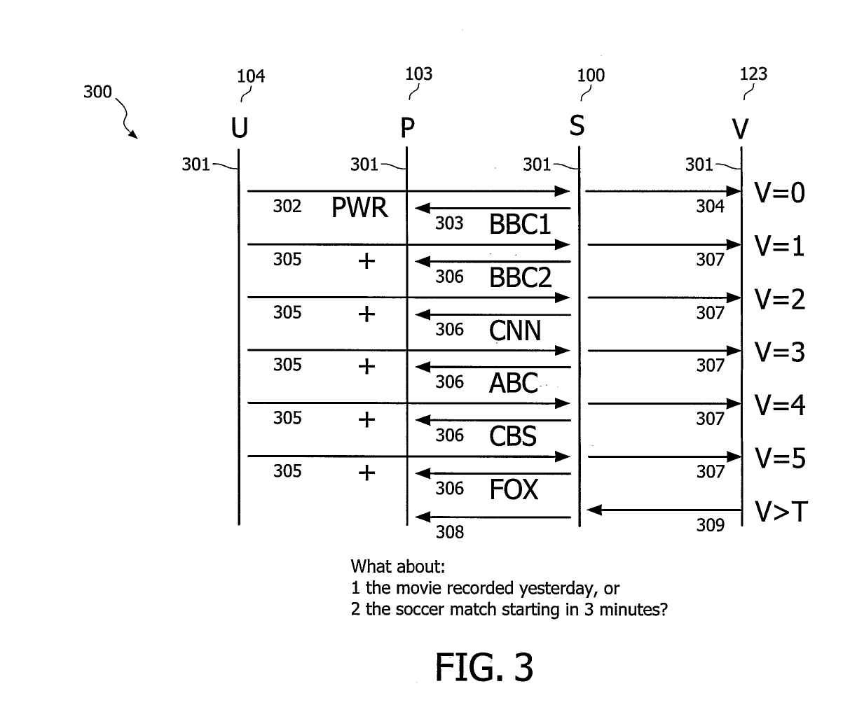

FIG. 3 shows an example of a sequence diagram of a method according to the invention.

In FIG. 1, a content-processing system 100 processes a content 102 for presentation 103 to a user 104. The content-processing system 100 may be e.g. a television set, a media player such as a Discman or MP3-player, an Internet browser, a receiver for Internet radio, or a game console, and it may have the purpose of entertaining the user 104 by presenting the content 102. The processing operation 101 may have the purpose of tailoring the presentation 103 to the wishes of the user 104.

The content-processing system 100 has input means 105 for receiving 106 commands 107 from the user 104 to control 108 the processing operation 101. The user 104 may tailor the presentation 103 by giving commands 107 to the input means 105. The input means 105 may e.g. be a remote control or buttons on the device. The commands 107 may have the purpose of selecting other content 102 for presentation 103, for instance, the channel-up and channel-down buttons on a remote control of a television set. The content 102 may e.g. be a television broadcast in a DVB format, or a webcast in an Internet streaming format like a Windows Media format.

The content 102 may be a song or movie stored on a local storage medium, e.g. a song in the format of an MP3 track stored in a solid-state memory, or a movie stored in a DVD format on an optical disc.

The content-processing system 100 has a mood detector 109 for detecting a mood 110 of the user 104. The mood 110 detected may be used to improve the user interface of the content-processing system 100, because it enables the content-processing system 100 to tailor the content 102 or the presentation 103 of the content 102 to the mood 110 of the user 104. The user interface may be improved, for instance, by matching the content 102 with the mood 110 detected.

The content-processing system 100 is arranged to modify 111 the processing operation 101 in dependence on the commands 107 received 106. A tuner may tune to a subsequent preset frequency in a list of preset frequencies, in response to receiving 106 the channel-up command 107. If the tuner was already tuned to the last frequency of the list when the channel-up command 107 was received 106, the tuner may wrap around and tune to the first frequency in the list, in response to receiving 106 the channel-up command 107. Similarly, the tuner may wrap around in the other direction in response to receiving 106 a channel-down command 107.

The mood detector 109 is coupled 112 to the input means 105. This enables the mood detector 109 to detect a mood 110 in dependence on the commands 107 received 106. The coupling 112 effectively enables the commands 107 received 106 to be communicated from the input means 105 to the mood detector 109.

The mood detector 109 is arranged to detect the mood 110 based on the received 106 commands 107. This can be achieved, for instance, by detecting a presence of a pattern 115 in the received 106 commands 107, or by detecting a relatively high frequency of received 106 commands 107.

Pattern analysis means 113 may be used to detect a presence of a pattern 115 in the received 106 commands 107. The pattern analysis means 113 may be a software routine that is executed on a processor in the content-processing system 100.

The mood detector 109 may detect a state of boredom 116 by detecting a relatively high frequency of received 106 commands 107. In the case of a television set, if the user 104 issues channel-up or channel-down commands 107 at a relatively high frequency, the user 104 is apparently not satisfied with the content 102 presented and likely to be easily distracted. The content-processing system 100 may then present alternative content 118, such as programs on a video recorder or a PVR which may be coupled to, or comprised by, the content-processing system 100. Programs that were stored but not retrieved for presentation 103 to the user 104 may be suggested to the user 104 with an overlay image.

The mood detector 109 has optional measuring means 119 for determining a measure of the received 106 commands 107. The mood detector 109 is arranged to detect the mood 110 if the measure exceeds a threshold 121. A comparator may easily detect the measure exceeding the threshold 121. The measure may have an averaging effect over time, such that shorter intervals with a high frequency of received 106 commands 107 do not immediately cause detection of the mood 110. For a television set, the measure may e.g. be the number of channel-changing commands 107 in the last five seconds, while the threshold 121 is four.

The measure and the threshold 121 do not have to be single-valued, but may have more dimensions. An example with two dimensions is that the measure has a first dimension with the number of commands 107 received 106 in the last minute, and a second dimension with the number of channel-changing commands 107 in the last five seconds. The threshold 121 has a first dimension being e.g. six and a second dimension being e.g. ten. There are at least two alternatives for comparing the measure with the threshold 121. In a first alternative, the measure exceeds the threshold 121 if each one of the respective dimensions does. In a second alternative, the measure exceeds the threshold 121 if any one of the dimensions does. The measuring means 119 may be stored as a value 123 in storage means 122. The value 123 may represent at least part of the history of received 106 commands 107. The measuring means 119 update 124 the value 123, in response to reception of a command 107.

To obtain an averaging effect over time, the measuring means 119 optionally have a timer 125 for determining a time interval and means for incrementing and decrementing 126 the value 123. In one example, the value 123 is decremented with each received 106 command 107 by the time in seconds since the previously received 106 command 107, and incremented by one if the received 106 command 107 has the purpose of selecting another content 102. In this example the threshold 121 may e.g. be five.

In one example of the content-processing system 100, the user 104 is watching a video tape in a VCR or a DVD-disc in a DVD-player. When repeatedly fast forward winding or rewinding the movie, the user 104 may be looking for a specific part or scene of the movie, or a specific chapter of the DVD-disc. In response to detecting this, the system may present alternative content to the user 104, for instance, an overview of the movie, tape or DVD, or a “movie-in-a-minute” overview, where key frames of the movie are presented. This may also apply to audio tapes and a TiVO box.

Similarly, in a system with a digital photobook, a user 104 may scroll through the images one by one. If the user 104 scrolls fast or back and forth for a while, the system may present an overview of the images based on meta data of the images, for instance, sorted by date, source, theme, and so on.

The mood detector 109 may detect a state of boredom 116 or a lack of interest if the commands 107 received 106 result in zapping, channel surfing, resorting to teletext, advertisements or commercials being presented like TellSell programs, or presenting an evening program carrousel.

The mood detector 109 may detect the user 104 being interested if the commands 107 received 106 result in an increase of a volume level, a switching back and forth between two channels, or particular teletext pages being presented, like topical pages containing specific and detailed information.

The user 104 may give commands 107 by pressing keys e.g. on a remote control. If a channel is selected by pressing keys with digits, thus entering a number denoting the preferred channel, the mood detector 109 may detect interest, or the value 123 may be decremented. If the next or previous channel is selected, the value 123 may be incremented. If, however, commercials or advertisements were presented while the next or previous channel was selected, incrementing the value 123 may be suppressed. Similarly, the value 123 may be incremented in response to teletext being used, unless a teletext page is presented that pertains to the program that was just previously being presented. In response to switching back and forth between two programs, the mood detector 109 may detect an interest in both programs and suggest or start recording either or both of the programs. In response to fast forwarding or fast rewinding the content 102 repeatedly or for a while, the mood detector 109 may detect the user 104 looking for a particular scene and the system may present a table of contents of the content 102.

FIG. 2 shows a flowchart illustrating mood detection according to the invention. The flow starts with an initialization 200 of the storage means 122 for the value 123, effectively setting the value 123 to zero. This step may also comprise setting other registers or memory to a suitable initial value, for instance, a register for an operand as an increment or a decrement. This step may be performed e.g. in response to a power-up or another trigger like a reset signal. After initialization, the flow determines if a command 107 has been received 106 201. If not, this step is repeated, after optionally performing another step for another purpose 202, to avoid occupying a controller executing the flow. If, however, a command 107 has been received 106, the flow continues by determining 203 if the command 107 has the purpose of selecting another content 102 for presentation 103. An increment operand is incremented with one if this is the case. Subsequently, the increment operand is decremented by two if the other content 102 was selected by directly dialing the digits 204 of the other content 102. If the current content 102 is a commercial 205, the increment operand is subsequently divided by two. If teletext is currently presented 206, the increment operand is incremented by one. If the teletext content 102 currently being presented pertains to television programs 207, however, the increment operand is subsequently decremented by two. If the command 107 has the purpose of fast forwarding the content 102 or of fast rewinding the content 102 208, the increment operand is incremented by two.

In a subsequent step 209, the value 123 is updated by adding the increment operand to the value 123 and subtracting the seconds elapsed since the last update 124 of the value 123, as counted by the timer 125.

The resulting value 123 is an indicator for a bored user 104. It is compared 210 with the threshold 121. If the threshold 121 is not exceeded, the flow continues with the previously described step 201 of determining if a further command 107 has been received 106. If the threshold 121 is exceeded, the flow continues by presenting an alternative content 212 118, followed by the same previously described step 201.

Presenting alternative content 118 may comprise presenting a content 102 suggestion. Examples of a content 102 suggestion are an overlay image with programs that have been recorded but not yet viewed, an EPG with advice tailored to the mood 110 of the user 104, and an EPG showing only the programs that are about to start in the next, say, ten minutes.

FIG. 3 shows an example 300 of a sequence diagram of the method according to the invention. In the diagram, the vertical lines 301 represent from left to right, respectively: the user 104, the presentation 103, the system, and the value 123. A sequence of events is indicated from top to bottom, wherein each event is represented by an arrow. The system is powered up with e.g. an initial power-on command 302 from the user 104. The system responds, for instance, by presenting 303 to the user 104 a content 102 dubbed “BBC1”, e.g. the first British public television channel and by initializing 304 the value 123. Subsequently, in this example 300, the user 104 issues a command 305 to proceed to a subsequent preset. The system responds by e.g. presenting 306 content 102 dubbed “BBC2”, and by updating 307 the value 123. After the user 104 issues the previous command 305, for example, 5 times within e.g. 5 seconds, the value 123 exceeds 309 the threshold 121 and an alternative content 118 is presented 308, comprising e.g. an overlay with suggestions for other content.

An embodiment of a computer program product according to the invention is a client application of a web browsing system. The client application runs on a node e.g. a general-purpose computer, and analyses a web page being presented to the user 104, and determines a ratio of meta-content over content 102 of the web page. If the ratio exceeds a threshold 121, the client application presents alternative content 118, for example, a portal of a search engine. The ratio may be determined by analysing a syntax of the web page like HTML, and by e.g. dividing the number of symbols or characters in links by the total number of symbols or characters on the web page. In a refined client application, the threshold 121 is applied to an average of the ratios of consecutive web pages being presented. The average may take the presentation 103 time of a web page into account to obtain a weighted average over time. The weighted average is an indicator for restlessness of the user 104. Determining the ratio may alternatively be performed at a server node of the web browsing system, rather than at a node where the client application is executed.

It is noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. Use of the article “a” or “an” preceding an element or step does not exclude the presence of a plurality of such elements or steps. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage. A ‘computer program’ is to be understood to mean any software product stored on a computer-readable medium, such as a floppy-disk, downloadable via a network, such as the Internet, or marketable in any other manner.

1. A content-processing system (100) for processing (101) a content (102) to be presented (103) to a user (104), the content-processing system (100) comprising:
input means (105) for receiving (106) commands (107) from the user (104) to control (108) the processing operation (101);
a mood detector (109) for detecting a user's (104) mood (110), the mood detector (109) being coupled (112) to the input means (105), the content-processing system (100) being arranged to modify (111) the processing operations (101) in dependence on the commands (107) received (106), and the mood detector (109) being arranged to detect the mood (110) based on the received commands (107).

2. A content-processing system (100) as claimed in claim 1, wherein the mood detector (109) comprises pattern analysis means (113) for detecting a presence of a pattern (115) in the received commands (107), and wherein the mood detector (109) is arranged to detect the mood (110) based on detecting the presence of the pattern (115).

3. A content-processing system (100) as claimed in claim 2, wherein the mood (110) is a state of boredom (116), and wherein the pattern (115) is a relatively high frequency of received commands (107).

4. A content-processing system (100) as claimed in claim 3, wherein the content-processing system (100) is arranged to present alternative content (118) in response to detection of the state of boredom (116) by the mood detector (109).

5. A content-processing system (100) as claimed in claim 1, wherein the mood detector (109) comprises measuring means (119) for determining a measure of the received commands (107) and wherein the mood detector (109) is arranged to detect the mood (110) if the measure exceeds a threshold (121).

6. A content-processing system (100) claimed in claim 5, wherein the measuring means (119) comprise storage means (122) for storing a value (123), and wherein the measuring means (119) are arranged to update (124) the value (123), in response to a command (107) being received (106).

7. A content-processing system (100) as claimed in claim 6, wherein the measuring means (119) comprise:
a timer (125) for determining a time; and
means for incrementing and decrementing (126) the value (123), wherein the measuring means (119) are arranged to increment the value (123) with an increment in dependence on the command (107) being received (106), and wherein the measuring means (119) are arranged to decrement the value (123) with a decrement in dependence on the time.

8. A mood detector (109) for use in the content-processing system (100) as claimed in claim 1.

9. A method for processing (101) a content (102) to be presented (103) to a user (104), the method comprising the steps of:
receiving (106) commands (107) from the user (104) to control (108) the processing operation (101);
modifying (111) the processing operation (101) in dependence on the commands (107) received; and
detecting (109) a mood (110) of the user (104) based on the received (106) commands (107).

10. A computer program product operative to cause a programmable content-processing system (100) to execute the steps of the method as claimed in claim 9.
